(19) United States
(12) Patent Application Publication
(10) Pub. No.: US 2004/0265112 A1
(43) Pub. Date: Dec. 30, 2004

(54) Device for suspending a load from a sky boom

(75) Inventor: Franciscus Jitte Maria Nieuwenhuis, Amerongen (NL)

Correspondence Address: Richard L. Byrne, WEBB ZIESENHEIM LOGSDON ORKIN & HANSON, P.C., 700 Koppers Building, 436 Seventh Avenue, Pittsburgh, PA, 15219-1818, US

(73) Assignee: Bonte Zwolle B.V., Zwolle (NL)

(21) Appl. No.: 10/808,202

(22) Filed: Mar. 24, 2004

(30) Foreign Application Priority Data
Mar. 24, 2003 (NL) 1022999

(51) Int. Cl. B66C 23/00

(52) U.S. Cl. 414/744.5

(57) ABSTRACT

Disclosed is a suspension device for suspending a load, such as an equipment rack, from a sky boom which includes two carriers extending along opposite sides of the loads. A horizontal element connects the carriers above the load and has a pickup point for the sky boom. A cover member extends from the connecting element along a third side of the load. The pickup point is situated substantially over the center of gravity of the load. The cover member is embodied as a carrier as well, in which case the pickup point is centrally situated with respect to the three carriers. A combination of a sky boom and the suspension device is also disclosed.

### BACKGROUND OF THE INVENTION

1) Field of the Invention

The invention relates to a suspension device for suspending a load from a sky boom.

2) Brief Description of the Prior Art

A suspension device for suspending a load from a sky boom is well known in the medical art. Sky booms are used in particular in operating rooms for movably suspending from the ceiling the equipment that is needed during operations. Such a suspension has the advantage that the space around the actual operating table remains free so that doctors and assistants performing an operation have good access to the patient on the table. In that respect it is especially important that cables and conduits through which e.g. electrical power, oxygen etc. may be supplied to the equipment are guided along or through the sky boom so as to keep the floor free of any obstacles.

At the moment two types of suspension are in general use.

A first type, which is mainly used for suspending equipment racks having a housing on three sides, comprises a pickup point for connection to the sky boom, which is attached to the back wall of the housing. At the location of the pickup point the back wall has an opening for receiving the cables and conduits coming from the sky boom. This known suspension has the drawback that the load, in this case the equipment rack, exerts a large moment on the pickup point and on the end of the sky boom, as the center of gravity of the load is situated some distance in front of the pickup point.

Another widespread type of suspension is used in combination with equipment racks that are open on two sides. In this known suspension the pickup point is arranged on top of an inverted U-shaped bracket, of which the legs extend downward on opposite sides of the equipment rack and are connected to the side walls of the rack. This type of suspension has the advantage that the pickup point is situated almost exactly over the center of gravity of the rack so that the resulting moment is negligible. On the other hand, the main drawback of this way of suspending the rack is that the cables and conduits running from the end of the sky boom to the back of the equipment arranged in the rack are exposed so that there is a risk that these may be inadvertently hit or even pulled loose.

### SUMMARY OF THE INVENTION

The invention has for its object to propose an improved suspension in which the above drawbacks are obviated. In accordance with a first aspect of the invention a suspension device is provided, which comprises at least two structural carrier members extending along opposite sides of the load, at least one structural top element connecting the structural carrier members above the load and having a pickup point for the sky boom, and at least one cover member extending from the connecting element along a third side of the load, said cover member being adapted for receiving cables and/or conduits running from the sky boom to the load. By this arrangement the weight of the load may be transferred to the suspension in a very efficient manner while the cover member may protect any cables and conduits.

In order to avoid as much as possible moments from being generated the pickup point is preferably situated substantially over the center of gravity of the load.

In a preferred embodiment, the pickup point may be situated substantially in a plane defined by the structural carrier members on the opposite sides to prevent the cover member from being subject to loading.

Furthermore, the cover member is at least partly open on a side facing the load to allow access to the cables and/or conduits. Alternatively, the cover member includes a plurality of sockets and/or connectors facing the load.

An efficient structure is obtained when the cover member is embodied as a structural carrier member as well, and the pickup point is centrally situated with respect to the three structural carrier members.

In order to protect the load from external influences the suspension device may further comprise wall parts arranged between the structural carrier members and the cover member.

In a preferred embodiment the load is an equipment rack, e.g. for carrying equipment used in an operating room. In that case the equipment rack may be structurally integrated with the suspension device in that the rack may include at least one shelf directly connected to the structural carrier members.

With a view to the desired movements of the load the pickup point preferably comprises a bearing.

In accordance with a second aspect the invention provides a suspension device for suspending a load from a sky boom, comprising first and second structural carrier members extending downward along two opposite sides of the load; a third structural carrier member extending downward along a third side of the load between said two opposite sides thereof, said third structural carrier member being adapted for receiving cables and/or conduits running from the sky boom to the load; and a structural top element connecting the first, second and third structural carrier members above the load, said top element having a pickup point for the sky boom.

Finally, the invention provides a combination of a sky boom and the suspension device as described above.

### BRIEF DESCRIPTION OF THE DRAWINGS

The invention is now illustrated by way of two embodiments, with reference being made to the annexed drawing, in which:

FIG. 1 shows a perspective view of a sky boom and a load suspended therefrom by means of a suspension device in accordance with a first embodiment of the invention, and

FIG. 2 is a perspective view of a load and a second embodiment of the suspension device in accordance with the invention.

### DETAILED DESCRIPTION OF THE INVENTION

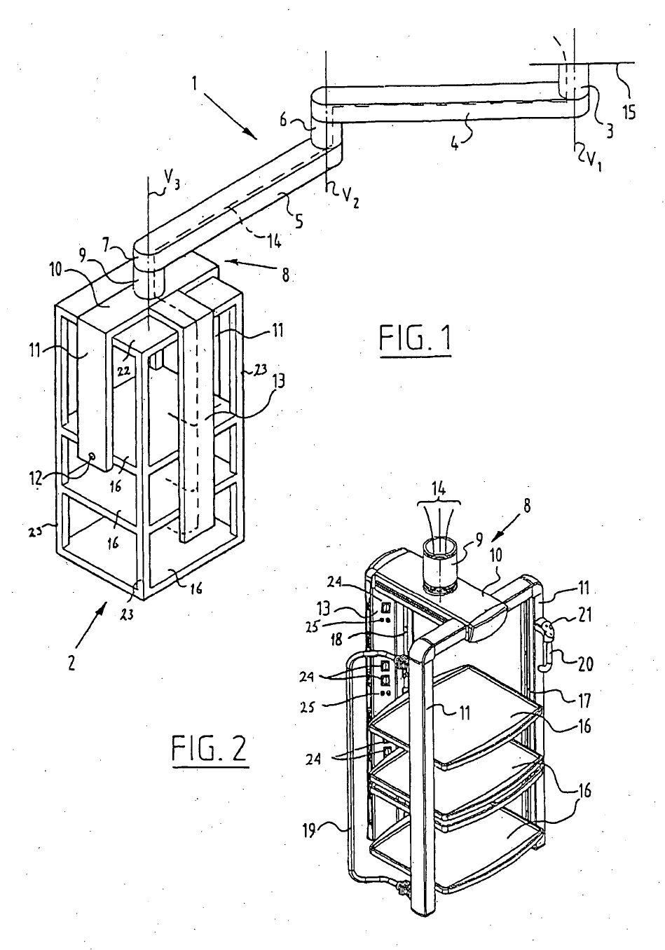

A sky boom 1 that is used for suspending a load 2, for instance a rack filled with equipment, from a ceiling comprises a main bearing 3 mounted on the ceiling 15 (FIG. 1), by which the boom 1 as a whole is rotatable about a first vertical axis V₁. In the illustrated embodiment the boom 1 consists of two horizontal parts 4, 5, which are mutually connected by an auxiliary bearing 6, by which they are rotatable with respect to each other about a second vertical axis V₂. The sky boom 1 serves not only for suspending the load 2, but also for guiding cables and conduits from the ceiling 15 to the load 2. These may include electrical power supply cables, conduits for supplying air or oxygen, and the like. These cables and conduits, which are generally indicated by reference numeral 14, are schematically illustrated in the drawing by dashed lines.

The load 2 is suspended from the distal end 7 of the second boom 5 opposite the auxiliary bearing 6 by means of a suspension device 8 in accordance with the invention. This suspension device 8 comprises a pickup point 9, formed by a bearing, which is mounted on with the distal end 7 of the boom part 5, and by which the load 2 is rotatable with respect to this boom part 5 about a third vertical axis V₃.

The pickup point 9 is formed on a horizontal structural top element 10, from which two structural carrier members 11 extend downwards on opposite sides of the load 2, which in this embodiment is an open equipment rack. In this embodiment the equipment rack is a self-supporting structure, comprising a plurality of shelves 16 and a top 22 all connected to corner posts 23. In the illustrated embodiment the carrier members 11 and the pickup point 9 are situated in a vertical plane which preferably substantially coincides with the center of gravity of the load 2. Connecting points 12 to which the load 2 is attached are formed near the lower ends of the carrier members 11.

On a third side of the rack a cover element 13 extends from the horizontal top element 10. Cables and conduits 14 are guided from the sky boom 1 to the back of the equipment in the rack 2 through this cover element 13. The cover element 13 may be open at the side directed towards the rack so as to provide access to the cables and conduits 14.

In an alternative embodiment of the suspension device 8 in accordance with the invention, which is the preferred embodiment at the moment, the cover member 13 is also embodied as a structural carrier member (FIG. 2). In this way a more efficient structure is obtained, since the cover element 13 does not only receive the cables and conduits 14, but also bears part of the weight of the load 2. The cover element 13 may be provided with a plurality of sockets 24 and connectors 25 for connecting equipment arranged in the rack 2 to the cables and conduits 14.

In this embodiment the pickup point 9 is situated essentially centrally with respect to the three structural carrier members 11, 13, again as close as possible to the center of gravity of the load 2. To this end the two carrier members 11 on the opposite sides of the load 2 are situated further to the open or front side of the load 2 in comparison to the first embodiment, so that the suspension device 8 in this embodiment has a T-shape plan form.

In this embodiment shelves 16 are directly suspended from the carrier members 11, 13 so that there is no longer a separate rack. Guides 17, 18 are formed at the inside of the carrier members 11, 13, the shelves 16 being height-adjustable along these guides 17, 18.

The suspension device 8 is conventionally provided with a movable grip 19, by which the equipment rack may be moved to a desired position. Besides, a second grip 20 is provided, including an operating panel 21 for a drive which may be installed, but which is not illustrated here, for driving the rack to a desired position. This is especially important when the rack carries a heavy load of equipment.

In this way the invention provides a suspension in which the generation of moments at the location of the pickup point 9 is reduced as much as possible, so that the bearing at the pickup point 9 is not incorrectly loaded. Moreover, in this suspension device the cables and conduits 14 are not exposed anywhere, so that there is no risk that these will get stuck or pulled loose.

Although the invention has been described by way of a number of exemplary embodiments, it will be clear that it is not limited thereto. The shape and dimensions of the suspension device could be varied in many ways. For instance, more than one structural carrier member might be provided on each side of the load. Also the structural top element and carrier members could be integrally formed as a unitary bracket. The way in which the pickup point is embodied could also be varied, for instance to allow movement of the load about a horizontal axis as well. On the other hand the pickup point might also be embodied as a fixed point, rather than a bearing. The sky boom may also include more or less segments and bearings than shown here. Finally, it is clear that various loads may be suspended from the inventive suspension device. The scope of the invention is defined exclusively by the following claims.

1. A suspension device for suspending a load from a sky boom, comprising:
at least two structural carrier members extending along opposite sides of the load;
at least one structural top element connecting the structural carrier members above the load and having a pickup point for the sky boom; and
at least one cover member extending from the connecting element along a third side of the load, said cover member being adapted for receiving cables and/or conduits running from the sky boom to the load.

2. The suspension device as claimed in claim 1, wherein the pickup point is situated substantially over the center of gravity of the load.

3. The suspension device as claimed in claim 1, wherein the pickup point is situated substantially in a plane defined by the structural carrier members on the opposite sides.

4. The suspension device as claimed in claim 1, wherein the cover member is at least partly open on a side facing the load to allow access to the cables and/or conduits.

5. The suspension device as claimed in claim 1, wherein the cover member includes a plurality of sockets and/or connectors facing the load.

6. The suspension device as claimed in claim 1, wherein the cover member is embodied as a structural carrier member as well, and wherein the pickup point is centrally situated with respect to the three structural carrier members.

7. The suspension device as claimed in claim 1, further comprising wall parts arranged between the structural carrier members and the cover member.

8. The suspension device as claimed in claim 1, wherein the load is an equipment rack.

9. The suspension device as claimed in claim 8, wherein the equipment rack includes at least one shelf directly connected to the structural carrier members.

10. The suspension device as claimed in claim 1, wherein the pickup point comprises a bearing.

11. A combination of a sky boom arrangement including a main bearing for rotatable mounting to a ceiling and at least one substantially horizontal boom extending from said main bearing and at least one suspension device rotatably mounted on a distal end of said at least one horizontal boom opposite the main bearing, said at least one suspension device including at least substantially parallel structural carrier members interconnected by a structural top element and at least one cover member extending from the top element between the carrier members.

12. A suspension device for suspending a load from a sky boom, comprising:
first and second structural carrier members extending downward along two opposite sides of the load;
a third structural carrier member extending downward along a third side of the load between said two opposite sides thereof, said third structural carrier member being adapted for receiving cables and/or conduits running from the sky boom to the load; and
a structural top element connecting the first, second and third structural carrier members above the load, said top element having a pickup point for the sky boom.

13. The suspension device as claimed in claim 12, wherein the load is an equipment rack having at least one shelf directly connected to the structural carrier members.

14. The suspension device as claimed in claim 13, wherein the third structural carrier member is at least partly open on a side facing the equipment rack to allow access to the cables and/or conduits.

15. The suspension device as claimed in claim 13, wherein the third structural carrier member includes a plurality of sockets and/or connectors facing the equipment rack.
